(19) United States
(12) Patent Application Publication
(10) Pub. No.: US 2011/0161404 A1
(43) Pub. Date: Jun. 30, 2011

(54) SYSTEMS AND METHODS FOR COMMUNICATING DATA BETWEEN A SERVER AND A DEVICE ON A VIRTUAL DESKTOP

(75) Inventors: Ed Ekstrom, Holladay, UT (US); James Turner, West Jordan, UT (US)

(73) Assignee: NIMBUS IS, INC., Midvale, UT (US)

(21) Appl. No.: 12/651,352

(22) Filed: Dec. 31, 2009

(51) Int. Cl. G06F 15/16

(52) U.S. Cl. 709/203; 709/231

(57) ABSTRACT

A server-implemented method for communicating data between the server and a first device is described. Communications with the first device are established by emulating functions of a second device. A request to pass the data to the first device is received. A determination is made as to whether the data exist on the server. The data are streamed to a virtual desktop on the first device.

### BACKGROUND

The use of computer systems and computer-related technologies continues to increase at a rapid pace. This increased use of computer systems has influenced the advances made to computer-related technologies. Indeed, computer systems have increasingly become an integral part of the business world and the activities of individual consumers. Computer systems may be used to carry out several business, industry, and academic endeavors. The wide-spread use of computers has been accelerated by the increased use of computer networks, including the Internet. Many businesses use one or more computer networks to communicate and share data between the various computers connected to the networks. The productivity and efficiency of employees often requires human and computer interaction.

Users of computer technologies continue to demand that the efficiency of these technologies increase. These demands include improving the functionality of computing devices. For example, users demand that the effectiveness and productivity of portable computing devices improve. Portable computing devices may suffer from various drawbacks including security, data loss protection, convenience, and the like.

In some instances, a user may use a mobile communications device as a portable computing device. The capabilities of these communications devices, however, may limit the user's productivity. For example, a user may not be able to be fully productive using a mobile communications device instead of another portable computing device (such as a laptop). The network connection capabilities of a mobile communications devices may also be limited, which may limit the amount and types of data the mobile communications device transmits and/or receives. As a result, benefits may be realized by providing systems and methods for delivering data to and from a first device that emulates (or is) a mobile communications device to a second device that includes certain functions included in a fixed or portable computing device (such as a laptop) as well as the functionality to act as a computer server.

### SUMMARY

According to at least one embodiment, a server-implemented method for communicating data between a server and a first device is described. Communications with the first device are established by emulating functions of a second device. A request to pass the data to the first device is received. A determination is made as to whether the data exist on the server. The data are streamed to a virtual desktop on the first device.

In one example, the first device may be free of a central processing unit (CPU). The first device may also be free of an operating system (OS). Further, the first device may be free of storage for data.

In one embodiment, the second device may be a mobile communications device. For example, the mobile communications device may be a smartphone. In one configuration, the data may be a software application. The data may be streamed to the first device across a WiFi network connection. In one embodiment, the functions of the second device may be emulated by the server through a Windows Mobile Emulator installed on the server.

In one embodiment, an emulator module on the server may be replaced with an additional driver. The additional driver may be implemented to reduce a processor load on the server, remove one or more additional layers of protocols and processes from the server, and serve data between the server and the first device.

A server device configured to communicate data between the server device and a first device is also described. The server device may include a processor and memory in electronic communication with the processor. The server device may also include a wireless network driver configured to establish communication with the first device. The server device may further include an emulator module configured to emulate functions of a second device. In addition, the server device may include a virtual application module configured to receive a request to pass the data to the first device and determine whether the data exist on the server. The server device may also include a delivery module configured to stream the data to a virtual desktop on the first device.

A computer-program product for communicating data between a server and a first device is also described. The computer-program product may include a computer-readable medium having instructions thereon. The instructions may include code programmed to establish communications with the first device by emulating functions of a second device, and code programmed to receive a request to pass the data to the first device. The instructions may also include code programmed to determine whether the data exist on the server, and code programmed to stream the data to a virtual desktop on the first device.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram illustrating one embodiment of a server communicating with a plurality of clients across a network connection;

FIG. 2 is a block diagram illustrating a further embodiment of a server;

FIG. 3 is a block diagram illustrating one embodiment of a client computing device;

FIG. 4 is a flow diagram illustrating one embodiment of a method for configuring a server to communicate with a client;

FIG. 5 is a flow diagram illustrating one embodiment of a method for delivering applications and/or information to a client across a network connection;

FIG. 6 depicts a block diagram of a computer system suitable for implementing the present systems and methods; and

FIG. 7 is a block diagram depicting a network architecture in which client systems, as well as storage servers (any of which can be implemented using computer system), are coupled to a network.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The success of an organization may be predicated upon its ability to enable its workforce to be as effective and productive on the move as it is at the office. A likely solution to enable remote effectiveness and productivity may be a portable computing device, such as, but not limited to, a laptop computer. These computing devices may permit members of the workforce to maintain communications and progress on work projects while at a location remote to the organization. Laptops, however, may suffer from various drawbacks. For example, laptops may suffer from a lack of security and data loss protection. Data may be subject to loss through theft, damage, or equipment failure. In addition, laptops may be inconvenient for the user to transport, thereby diminishing the portability aspect. Further, the duration of a laptop battery is relatively short, lasting approximately two hours. The configuration, maintenance, and instability of an operating system and/or applications installed on laptops may also add to the drawbacks of relying on laptop computing devices to maintain productivity in remote locations.

Portable computing devices may also be fragile and unless specially built, may be easily damaged. In addition, the initial cost of these devices may be expensive. The cost of the applications required by the user may be expensive, as well as the ongoing maintenance associated with these portable computing devices. For example, laptops may not be equipped to operate critical enterprise level applications, such as custom billing systems, project management applications, and the like. If a laptop is equipped to operate these critical enterprise level applications, the cost may be prohibited to the majority of businesses needing that functionality. The cost of licensing multiple copies of productivity applications and operating systems may limit the number of laptops that may be purchased and maintained at any one time.

Users have attempted to overcome the drawbacks of laptops by using alternative portable computing devices. An example of such a device may be a smartphone. The smartphone may be used as the primary mobile computing device for certain users because smartphones may be capable of maintaining persistent network connections with access to remote servers and cloud-based IT solutions. Smartphones, however, may also suffer from various drawbacks. For example, the size of the display screen and keyboard provided on the smartphone may limit the productivity of the user.

In one embodiment, a combination of a laptop-type device and a smartphone (or a device emulating a smartphone) may allow users to utilize the power of their smartphones to a greater degree. The combination of the laptop-type device and the smartphone (or the device emulating a smartphone) may be referred to as a thin client.

In one configuration, the laptop-type device of the thin client may be free of a central processing unit (CPU), operating system (OS), or storage. The laptop-type device may also include a display screen that is larger and easier to view than the display screen included with the smartphone. In addition, the laptop-type device of the thin client may also include an input device, such as a keyboard, that is larger than the input device of the smartphone. The larger keyboard may allow the user to more easily interact with data displayed on the screen of the laptop-type device.

The combination of a laptop-type device and a smartphone, however, may not provide certain functions that a user may desire. Users may desire the power and flexibility of a laptop computer combined with the convenience, mobility, and security of a smartphone. For example, users may desire to interact with productivity applications specific to an organization without the need to connect a laptop-type device to a smartphone. The present systems and methods provide a user with a first device (such as a laptop-type device) that allows the user to enjoy the power and flexibility of a laptop computer while still retaining the mobility and security of a smartphone.

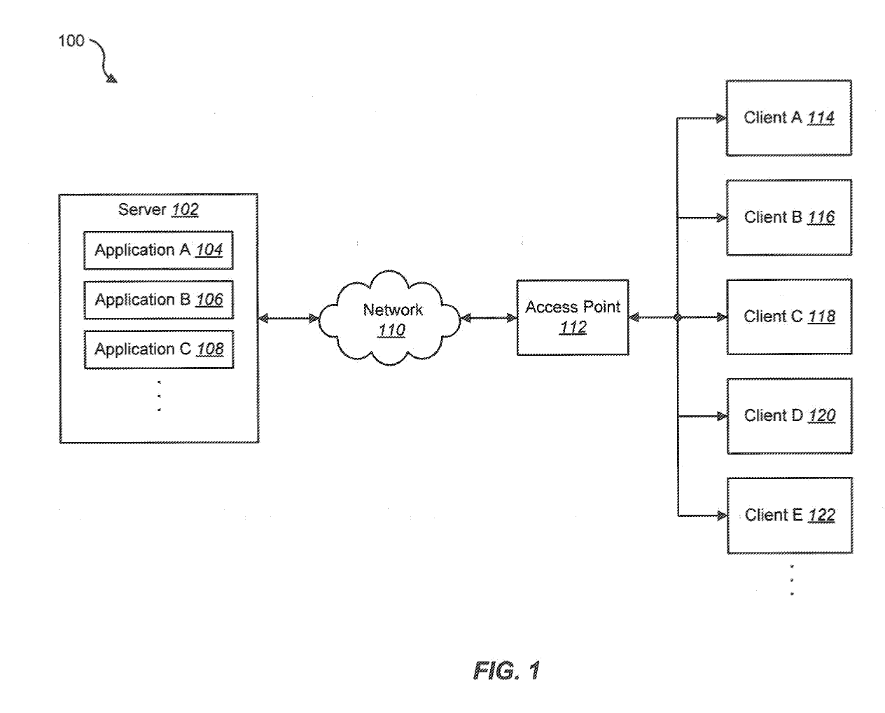

FIG. 1 is a block diagram illustrating one embodiment of a server 102 communicating with a plurality of clients 114, 116, 118, 120, 122 across a network connection 110. The clients 114, 116, 118, 120, 122 may connect to the network 110 via an access point 112. A system including the server 102, clients 114, 116, 118, 120, 122, and the access point 112 may be referred to as a “stack”.

In one embodiment, the server 102 may include one or more applications 104, 106, 108. In other words, application A 104, application B 106, and application C 108 may be installed and configured on the server 102. While only three applications are illustrated as being installed on the server 102, the server 102 may include more or less than three applications.

In one configuration, each of the clients communicating with the server 102 may be a computing device. For example, the client may be a personal computer (PC), a desktop computer, a server, a laptop, a laptop-type device, a personal digital assistant (PDA), a mobile computing device, and like. In one embodiment, each client 114, 116, 118, 120, 122 may be free of a separate central processing unit (CPU), operating system (OS), or storage. The lack of a separate CPU, OS, or storage in each of the clients may significantly reduce the amount of configuration, management, and security risks through data loss protection. In one embodiment, the server 102 may push or stream the applications 104, 106, 108 to one or more of the clients 114, 116, 118, 120, 122 across the network connection 110. In other words, the applications 104, 106, 108 may continue to be stored and installed on the server 102, and an application 104, 106, 108 may be viewed and interacted with on the client 114, 116, 118, 120, 122 in a virtual environment. In addition, data and information may flow from a client 114, 116, 118, 120, 122 to the server 102 across the network connection 110.

In another embodiment, the applications 104, 106, 108 may be related to home theater personal computer (PC) functionality. As a result, the server 102 may include functions relating to a home theater PC (or media PC). Media content may be passed to the clients 114, 116, 118, 120, 122 and displayed on the clients on a virtual desktop environment.

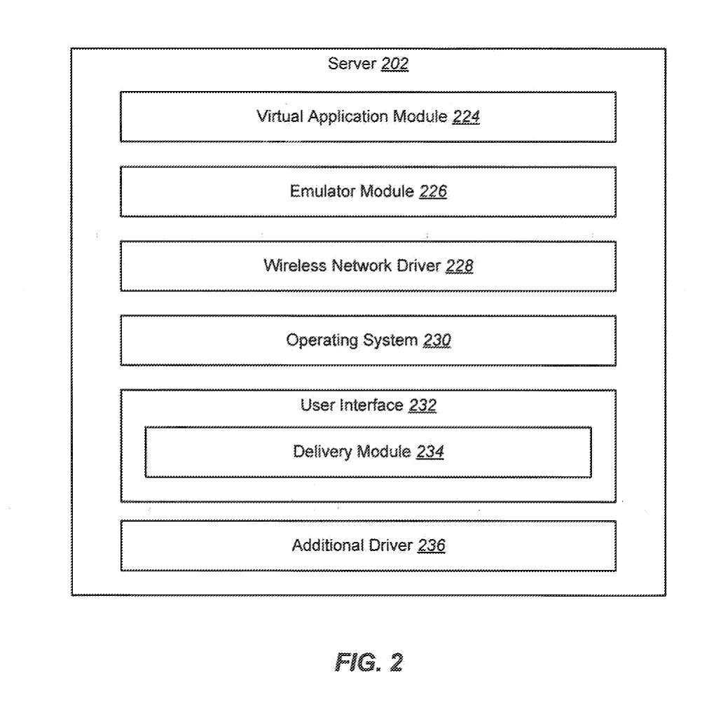

FIG. 2 is a block diagram illustrating a further embodiment of a server 202. The server 202 may be an out-of-the-box computer server, or a custom specified/manufactured computer server capable of supporting multiple clients. In one configuration, the server 202 may include a virtual application module 224. The virtual application module 224 may support separate desktop PC environments for each client that may be connected to the server 202. The virtual application module 224 may include, but is not limited to, Citrix XenApp fundamentals, Microsoft Remote Desktop Protocol (RDP), Microsoft Virtual PC, and Vmware.

The server 202 may also include an emulator module 226. An example of the emulator module 226 may be the Windows Mobile Emulator, a Blackberry OS emulator, an Adroid OS emulator, a Symbian OS emulator, and the like. In one configuration, the emulator module 226 may duplicate the functions of a system or device using the server 202, so that the server 202 behaves like the system or device. For example, the emulator module 226 may duplicate functions of a smartphone using the server 202, so that the server 202 behaves like a smartphone. In one configuration, clients (such as the clients 114, 116, 118, 120, 122) may be configured to communicate with a particular device (such as a smartphone). The emulator module 226 may allow the server 202 to emulate the functions of a smartphone. As a result, the clients 114, 116, 118, 120, 122 may also be enabled to communicate with the server 202 that is emulating the functions of a smartphone.

Because the server 202 may emulate the functions of a smartphone device, the server 202 may communicate with the one or more clients 114, 116, 118, 120, 122 using a Bluetooth or cellular connection via a wireless network driver 228. The driver 228, however, may also be WiFi enabled so that the server 202 may wirelessly communicate with client computing devices across a network connection 110. The wireless driver 228 may expand the connectivity option between the server 202 and the one or more clients 114, 116, 118, 120, 122 from the Bluetooth and/or cellular connection to a WiFi connection.

The server 202 may further include an operating system 230. The operating system 230 may allow the server 202 to support a connection with multiple clients. For example, the operating system 230 may allow the server 202 to support a connection with a minimum of five different clients. In one example, the operating system 230 installed on the server 202 may be, but is not limited to, the Windows Server 2008 (or other server) operating system.

In one embodiment, the server 202 may include a user interface 232 to allow a user to configure and operate the server 202. In one example, the user interface 232 may include a delivery module 234 that may be configured by the user of the server 202. The delivery module 234 may be a software client that facilitates the delivery of applications and information on to any device. For example, the delivery module 234 may facilitate the delivery of application A 104, application B 106, and application C 108 to one or more laptop-type devices (such as clients 114, 116, 118, 120, 122) communicating with the server 202 across the network connection 110. In one configuration, the delivery module 234 may be an Independent Computing Architecture (ICA) client for each virtual desktop implemented on each client 114, 116, 118, 120, 122. The ICA client may facilitate the deployment of applications and information from the server 202 to each of the virtual desktops on the client 114, 116, 118, 120, 122. The server 202 may also include a security layer (not shown) to protect the contents of the applications installed on the server 202. For example, the layer may include, but is not limited to, Wireless Encryption Protocol (WEP), WiFi Protected Access (WPA), WPA—Pre-Shared Key (WPA-PSK), WPA2, and the like.

In one configuration, the server 202 may also include an additional 236. The additional driver 236 may replace the emulator module 226. In one example, the additional driver 236 may include emulator functionality enabling the server 202 to emulate the behavior and functions of another device. In addition, the additional driver 236 may reduce the overall processor load on the server. Further, the additional driver 236 may remove additional layers of protocols and processes from the server 202. Reducing the processor load and removing additional layers of protocols and processes may allow resources on the server to become available to the server, which may then be served (or made available) to the clients 114, 116, 118, 120, 122.

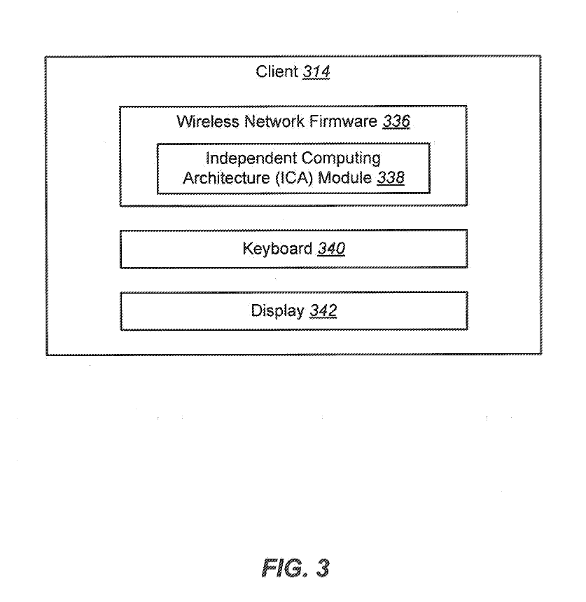

FIG. 3 is a block diagram illustrating one embodiment of a client computing device 314. As previously explained, the client 314 may be a laptop-type device that is free of a CPU, an OS, storage for data, and the like. The client 314 may include wireless network firmware 336 to enable the client 314 to communicate with a server 102 across a network connection 110. The combination of the client 314 and the server 102 (which may emulate the functions of a mobile communications device) may be a thin client.

The wireless network firmware 336 may be WiFi enabled firmware that enables connectivity to a WiFi access point, such as the access point 112, which in turn enables remote connectivity to the server 102. In another embodiment, the client 314 may include an ICA module 338 which may be embedded in the firmware 336. The client 314 may also include various input/output devices. For example, the client 314 may include a keyboard 340 and a display 342. In one embodiment, the client 314 may include a WiFi universal serial bus (USB) adaptor as part of the wireless network firmware 336. In another configuration, the firmware 336 may include an internal WiFi enabled device in order to provide wireless connectivity with the server 102 via the access point 112.

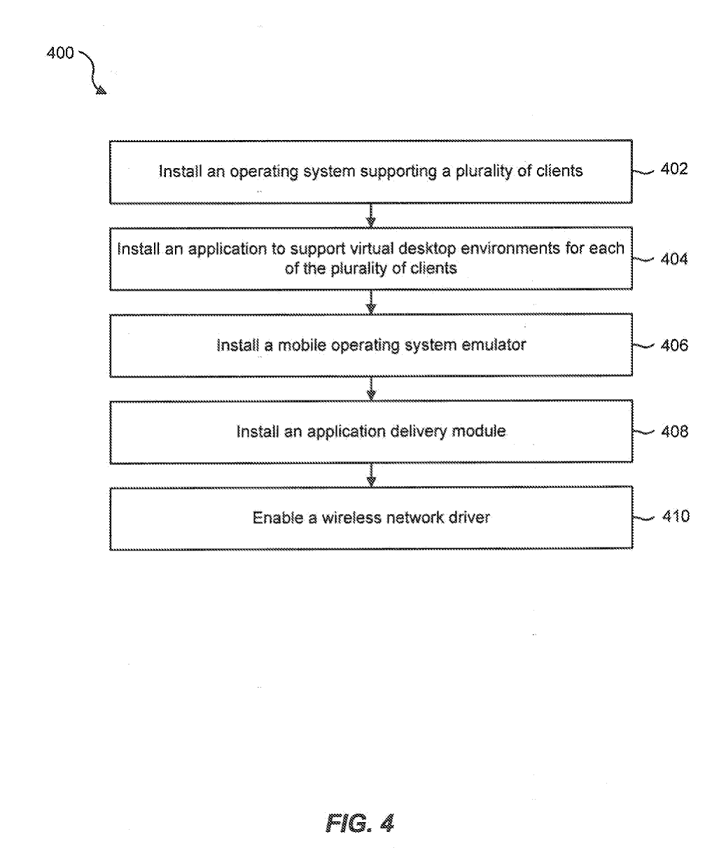

FIG. 4 is a flow diagram illustrating one embodiment of a method 400 for configuring a server to communicate with a client, such as a laptop-type device. In another embodiment, the server may communicate with a thin client, which is the combination of a mobile communications device and a laptop-type device. In one configuration, the server 102 may stream applications and/or information to one or more clients 114, 116, 118, 120, 122 across a network connection 110 such as a WiFi network. The streamed applications may be displayed on the client in a virtual environment. In other words, the applications may be installed only on the server 102, and streamed to the client so that it appears to a user of the client that the application is installed on the client.

In one embodiment, an operating system supporting a plurality of laptop-type devices may be installed 402 on the server 102. In addition, an application to support virtual desktop environments for each of the plurality of laptop-type devices may also be installed 404 on the client 102. Further, a mobile operating system emulator 406 may be installed. In one example, the mobile operating system emulator 406 may be the Window Mobile Emulator. Once the mobile operating system emulator 406 is installed on the server 102, the server 102 may emulate the behavior and functions of a mobile computing device, such as a smartphone.

In one configuration, an application delivery module 408 may be installed on the server 102. As explained previously, the application delivery module 408 may facilitate the delivery of applications and information from the server 102 to one or more laptop-type devices or mobile communications devices, such as a smartphone. In addition, a wireless network driver 410 may be enabled on the server 102. The wireless network driver 410 may be a WiFi enabled drive in order to expand the connectivity between the server 102 and the one or more laptop-type devices from a Bluetooth or cellular connection to a WiFi connection.

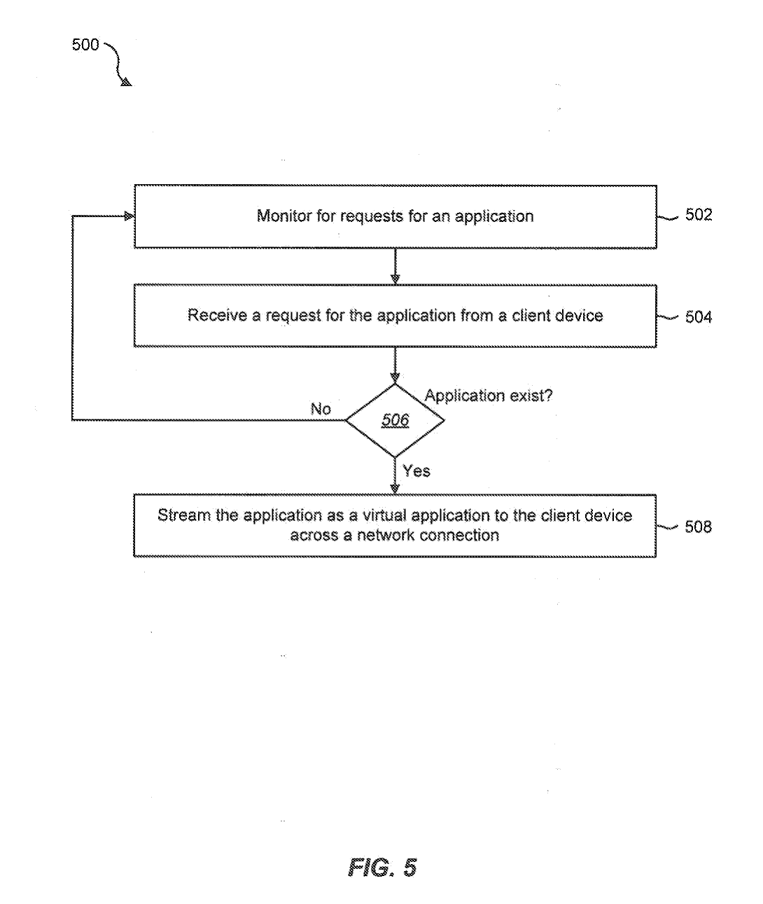

FIG. 5 is a flow diagram illustrating one embodiment of a method 500 for delivering applications and/or information to a laptop-type device across a network connection from a server 102 emulating a mobile communications device, such as a smartphone. In one configuration, the method 500 may be implemented by the server 102. As explained above, the one or more laptop-type devices may be free of a CPU, an OS, storage for data, and the like. In other words, the laptop-type devices may simply include an input/output component, such as, but not limited to, a keyboard and a display.

In one embodiment, requests for an application to be delivered may be monitored 502. A request for the application may be received 504 from a laptop-type device. A determination 506 may be made as to whether the application requested by the device exists on the server 102. In other words, a determination 506 may be made as to whether the requested application is installed on the server 102. If it is determined 506 that the applications does not exist on the server 102, the method 500 may return to monitor 502 for requests for an application. If, however, it is determined 506 that the application requested by the device does exit on the server 102, the application may be streamed 508 as a virtual application to the laptop-type device across a network connection. In other words the requested application continues to be stored on the server 102 while a user interacts with the application being streamed to the laptop-type device in a virtual environment.

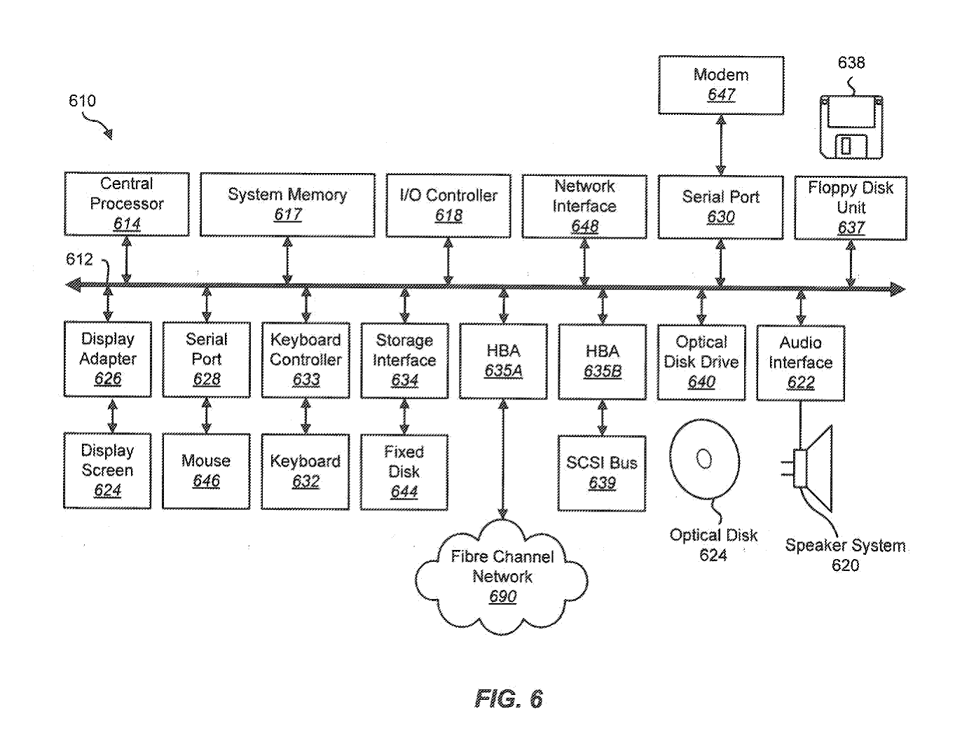

FIG. 6 depicts a block diagram of a computer system 610, such as the server 102, suitable for implementing the present systems and methods. Computer system 610 includes a bus 612 which interconnects major subsystems of computer system 610, such as a central processor 614, a system memory 617 (typically RAM, but which may also include ROM, flash RAM, or the like), an input/output controller 618, an external audio device, such as a speaker system 620 via an audio output interface 622, an external device, such as a display screen 624 via display adapter 626, serial ports 628 and 630, a keyboard 632 (interfaced with a keyboard controller 633), a storage interface 634, a floppy disk drive 637 operative to receive a floppy disk 638, a host bus adapter (HBA) interface card 635A operative to connect with a Fibre Channel network 690, a host bus adapter (HBA) interface card 635B operative to connect to a SCSI bus 639, and an optical disk drive 640 operative to receive an optical disk 642. Also included are a mouse 646 (or other point-and-click device, coupled to bus 612 via serial port 628), a modem 647 (coupled to bus 612 via serial port 630), and a network interface 648 (coupled directly to bus 612).

Bus 612 allows data communication between central processor 614 and system memory 617, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with computer system 610 are generally stored on and accessed via a computer readable medium, such as a hard disk drive (e.g., fixed disk 644), an optical drive (e.g., optical drive 640), a floppy disk unit 637, or other storage medium. Additionally, applications can be in the form of electronic signals modulated in accordance with the application and data communication technology when accessed via network modem 647 or interface 648.

Storage interface 634, as with the other storage interfaces of computer system 610, can connect to a standard computer readable medium for storage and/or retrieval of information, such as a fixed disk drive 644. Fixed disk drive 644 may be a part of computer system 610 or may be separate and accessed through other interface systems. Modem 647 may provide a direct connection to a remote device, such as a thin client, via a telephone link or to the Internet via an internet service provider (ISP). Network interface 648 may provide a direct connection to a remote client via a direct network link to the Internet via a POP (point of presence). Network interface 648 may provide such connection using wireless techniques, including digital cellular telephone connection, Cellular Digital Packet Data (CDPD) connection, digital satellite data connection or the like. The system 610 may also connect to the remote client using a wired connection such as, but not limited to, an Ethernet connection.

Many other devices or subsystems (not shown) may be connected in a similar manner (e.g., document scanners, digital cameras and so on). Conversely, all of the devices shown in FIG. 6 need not be present to practice the present disclosure. The devices and subsystems can be interconnected in different ways from that shown in FIG. 6. The operation of a computer system such as that shown in FIG. 6 is readily known in the art and is not discussed in detail in this application. Code to implement the present disclosure can be stored in computer-readable storage media such as one or more of system memory 617, fixed disk 644, optical disk 642, or floppy disk 638. The operating system provided on computer system 610 may be Windows Server 2008, MS-DOS®, MS-WINDOWS®, OS/2®, UNIX®, Linux®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present disclosure may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

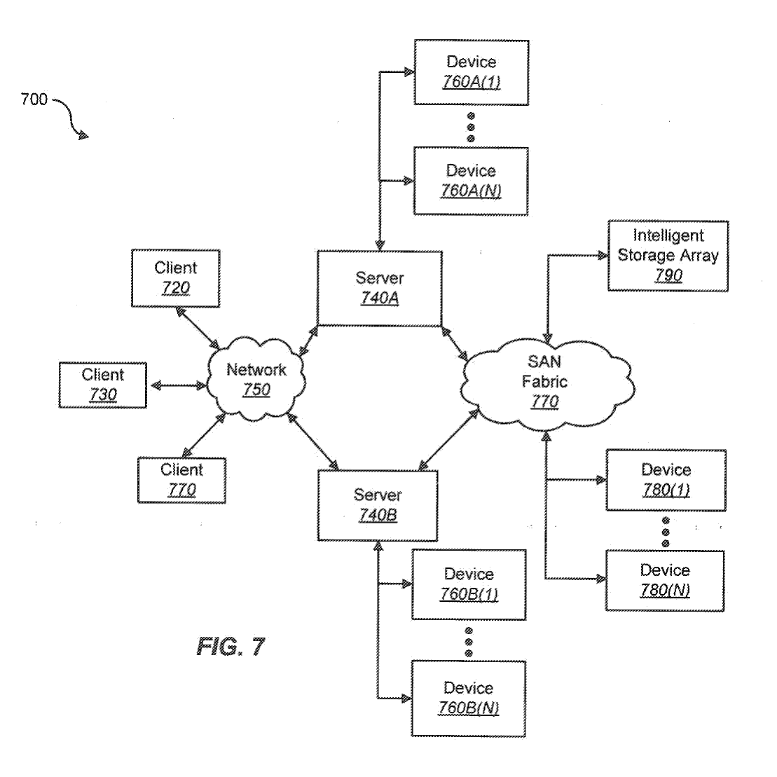

FIG. 7 is a block diagram depicting a network architecture 700 in which client systems 710, 720 and 730, as well as storage servers 740A and 740B (any of which can be implemented using computer system 710), are coupled to a network 750. The storage server 740A is further depicted as having storage devices 760A(1)-(N) directly attached, and storage server 740B is depicted with storage devices 760B(1)-(N) directly attached. SAN fabric 770 supports access to storage devices 780(1)-(N) by storage servers 740A and 740B, and so by client systems 710, 720 and 730 via network 750. Intelligent storage array 790 is also shown as an example of a specific storage device accessible via SAN fabric 770.

Data stored on the servers 740A or 740B may be streamed to client systems 710, 720 and 730 using a software client. Such a client allows client systems 710, 720 and 730 to access data hosted by storage server 740A or 740B or one of storage devices 760A(1)-(N), 760B(1)-(N), 780(1)-(N) or intelligent storage array 790. FIG. 7 depicts the use of a network such as the Internet for exchanging data, but the present disclosure is not limited to the Internet or any particular network-based environment.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of” In addition, for ease of use, the words “including” and “having,” as used in the specification and claims, are interchangeable with and have the same meaning as the word “comprising.”

What is claimed is:

1. A server-implemented method for communicating data between the server and a first device, comprising:
establishing communications with the first device by emulating functions of a second device;
receiving a request to pass data to the first device;
determining whether the data exist on the server; and
streaming the data to a virtual desktop on the first device.

2. The method of claim 1, wherein the first device is free of a central processing unit (CPU).

3. The method of claim 1, wherein the first device is free of an operating system (OS).

4. The method of claim 1, wherein the first device is free of storage for data.

5. The method of claim 1, wherein the second device comprises a mobile communications device.

6. The method of claim 5, wherein the mobile communications device comprises a smartphone.

7. The method of claim 1, wherein the data comprise a software application.

8. The method of claim 1, wherein the data are streamed to the first device across a WiFi network connection.

9. The method of claim 1, wherein the functions of the second device are emulated by the server through a Windows Mobile Emulator installed on the server.

10. The method of claim 1, further comprising replacing an emulator module on the server with an additional driver, wherein the additional driver is configured to reduce a processor load on the server, remove one or more additional layers of protocols and processes from the server, and serve data between the server and the first device.

11. A server device configured to communicate data between the server device and a first device, the server device comprising:
a processor;
memory in electronic communication with the processor;
a wireless network driver configured to establish communication with the first device;
an emulator module configured to emulate functions of a second device;
a virtual application module configured to receive a request to pass data to the first device and determine whether the data exist on the server; and
a delivery module configured to stream the data to a virtual desktop on the first device.

12. The server device of claim 11, wherein the first device is free of a central processing unit (CPU).

13. The server device of claim 11, wherein the first device is free of an operating system (OS).

14. The server device of claim 11, wherein the first device is free of storage for data.

15. The server device of claim 11, wherein the second device comprises a mobile communications device.

16. The server device of claim 15, wherein the mobile communications device comprises a smartphone.

17. The server device of claim 11, wherein the data comprise a software application.

18. The server device of claim 11, wherein the delivery module is further configured to stream the data to the first device across a WiFi network connection.

19. The server device of claim 11, wherein the server device further comprises an additional driver configured to replace the emulator module, wherein the additional driver is configured to reduce a processor load on the server, remove one or more additional layers of protocols and processes from the server, and serve data between the server device and the first device.

20. A computer-program product for communicating data between a server and a first device, the computer-program product comprising a computer-readable medium having instructions thereon, the instructions comprising:
code programmed to establish communications with the first device by emulating functions of a second device;
code programmed to receive a request to pass data to the first device;
code programmed to determine whether the data exist on the server; and
code programmed to stream the data to a virtual desktop on the first device.
